(19) United States
(12) Patent Application Publication
(10) Pub. No.: US 2020/0027021 A1
(43) Pub. Date: Jan. 23, 2020

(54) REINFORCEMENT LEARNING FOR MULTI-DOMAIN PROBLEMS

(71) Applicants: Kumara Sastry, Hillsboro, OR (US); Kenny K. Toh, Portland, OR (US); John A. Swanson, Forest Grove, OR (US); Vivek K. Singh, Portland, OR (US); Matthew K. Gumbel, Portland, OR (US); Manuj Swaroop, Beaverton, OR (US); Selim Dogru, Hillsboro, OR (US)

(72) Inventors: Kumara Sastry, Hillsboro, OR (US); Kenny K. Toh, Portland, OR (US); John A. Swanson, Forest Grove, OR (US); Vivek K. Singh, Portland, OR (US); Matthew K. Gumbel, Portland, OR (US); Manuj Swaroop, Beaverton, OR (US); Selim Dogru, Hillsboro, OR (US)

(21) Appl. No.: 16/585,851

(22) Filed: Sep. 27, 2019

(51) Int. Cl. G06N 20/00; G06N 5/04; G06F 17/50

(52) U.S. Cl. CPC G06N 20/00; G06F 17/5068; G06N 5/04

(57) ABSTRACT

Reinforcement learning methods are applied to the multi-domain problem of developing photoresist models for advanced semiconductor technologies. In an iterative process, candidate photoresist models are selected or generated, with each model comprising an optical imaging model, one or more analytical chemistry or deformation kernels, and one or more photoresist development model terms. Model parameters to be calibrated in an iteration are selected. The candidate photoresist models are calibrated to best fit photoresist contours extracted from SEM images. Values for the calibration model parameters are determined and the most useful analytical kernels are kept in each model while the others are dropped. A genetic algorithm uses the best calibrated photoresist models from the prior iteration to develop candidate models for the next iteration. The process iterates until no further accuracies can be gained. A residual minimization model can be trained to correct for residual errors in the final model.

### BACKGROUND

Cutting-edge semiconductor manufacturing processes are terribly complex. Housed in billion-dollar factories and comprising hundreds of processing steps to yield a finished device, they are capable of reliably printing features as small as 10 nm hundreds of billions of times across wafers that extend a foot in diameter. Developing a new semiconductor manufacturing process requires defining a set of design rules that establish constraints that a semiconductor device design must follow to ensure manufacturability. Process development also involves developing optical proximity correction (OPC) recipes that adjust physical design features before they are printed on a photomask to help counter feature distortions caused by various processing steps. Having accurate models for manufacturing processes, such as photolithography, are helpful for process development. In advanced technology nodes, new process models may need to be developed to account for physical effects not comprehended in process models for prior technology generations.

### BRIEF DESCRIPTION OF THE DRAWINGS

FIG. 1A illustrates the physical design of an exemplary planar transistor.

FIG. 1B illustrates an exemplary cross-section of the planar transistor of FIG. 1A taken along the line A-A′.

FIGS. 2A-2F illustrate an exemplary photolithography process.

FIGS. 3A-3D illustrate differences between features on a photomask and those manufactured on a wafer due to process distortion effects and the use of optical proximity correction to counter those effects.

FIG. 4 illustrates an embodiment of silicon data capture and utilization of silicon data to aid semiconductor manufacturing process development.

FIG. 5 illustrates an exemplary photoresist model.

FIG. 6 is an exemplary illustration of predicted photoresist contours after photoresist development.

FIG. 7 illustrates an exemplary reinforcement learning method for developing a photoresist model.

FIG. 8 illustrates an exemplary iteration and additional details of the reinforcement method of FIG. 7.

FIGS. 9A-9B illustrate photoresist contours for a target structure and corresponding predicted photoresist contours generated by existing photoresist models and a photoresist model developed using the technologies disclosed herein.

FIG. 10 is a block diagram of an exemplary photoresist modeling system.

FIG. 11 is an exemplary reinforcement learning method for generating photoresist models.

FIG. 12 is a block diagram of an exemplary computing device in which technologies described herein may be implemented.

FIG. 13 is a block diagram of an exemplary processor core that can execute instructions as part of implementing technologies described herein.

### DETAILED DESCRIPTION

Semiconductor manufacturing has become increasingly complex over the years. Since the turn of the century, the minimum feature size has shrunk by over an order of magnitude as the industry has progressed from the 130 nm to 10 nm technology nodes. At the same time, processor complexity has increased dramatically. Current flagship products have transistor counts that well exceed 10 billion. To handle these reduced feature sizes and increased chip complexities, companies must invest billions of dollars and years of research to build state-of-the-art fabrication facilities. Research and development costs are driven ever-upward by the rising cost of increasingly sophisticated equipment needed for advanced processes. The industry has taken steps to decrease per-transistor manufacturing costs (for example, by moving from 200 mm to 300 mm wafers at the 90 nm technology node), but the overall trend has been for each process generation to cost more than the last. With up to hundreds of individual dies on wafers that span a foot in diameter, the total number of transistors that can be printed on a wafer is on the order of one trillion. Developing high-volume manufacturing processes that can reliably manufacture transistors at such an extreme scale presents considerable challenges.

One such challenge is the development of accurate and fast photoresist models for new technologies. Existing compact fast photoresist models may not comprehend the physical and chemical processes needed to predict photoresist contours with enough accuracy in advanced semiconductor manufacturing processes. These models need to be accurate, quick, and developed within a reasonable amount of time.

The technologies described herein apply reinforcement learning techniques to multi-domain problems. These technologies are used to generate photoresist models for advanced technology nodes that are more accurate than existing approaches. Artificial intelligence approaches and algorithms derive photoresist models by iteratively calibrating a set of candidate photoresist models and using the best candidate photoresist models from the current iteration as input into a genetic algorithm that generates the set of candidate photoresist models for the next iteration.

An initial set of candidate photoresist models are assembled from a set of models, model terms, and kernels that model various aspects of the photolithography process. Each candidate photoresist model comprises an optical imaging model, one or more analytical chemistry kernels, one or more photoresist development model terms, and one or more analytical deformation kernels. Each candidate photoresist model is parameterized and a set of model parameters for each candidate photoresist model is selected for calibration. The candidate photoresist models are subjected calibrated wherein values for the model parameters selected for calibration are determined and the most useful analytical kernels are selected based on how well the candidate photoresist model predicts photoresist contours as compared to photoresist contours extracted from SEM images.

After being calibrated against a set of training data, each candidate photoresist model is cross validated with a separate set of validation data, and the candidate photoresist models that do the best job of accurately predicting photoresist contours are selected. The best calibrated candidate photoresist models are fed into a genetic algorithm that determines a set of new candidate photoresist models to be used in the next iteration of model calibration. The iterative process is repeated until the accuracy of the best calibrated candidate photoresist model for the current iteration provides no improved ability to predict photoresist contours over the best calibrated candidate photoresist model from the previous generation. The best calibrated candidate photoresist model of the final iteration is identified as a final photoresist model.

To improve upon the final photoresist model, a residual minimization model can be generated to correct for the systemic residual errors. The final photoresist model and residual minimization model can then be applied to photomask data of a semiconductor device to predict manufactured photoresist contours in advanced technology nodes.

In the following description, specific details are set forth, but embodiments of the technologies described herein may be practiced without these specific details. Well-known circuits, structures, and techniques have not been shown in detail to avoid obscuring an understanding of this description. “An embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or in any other manner. “Connected” may indicate elements are in direct physical or electrical contact with each other and “coupled” may indicate elements co-operate or interact with each other, but they may or may not be in direct physical or electrical contact.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to embodiments of the present disclosure, are synonymous.

Reference is now made to the drawings, wherein similar or same numbers may be used to designate same or similar parts in different figures. The use of similar or same numbers in different figures does not mean all figures including similar or same numbers constitute a single or same embodiment.

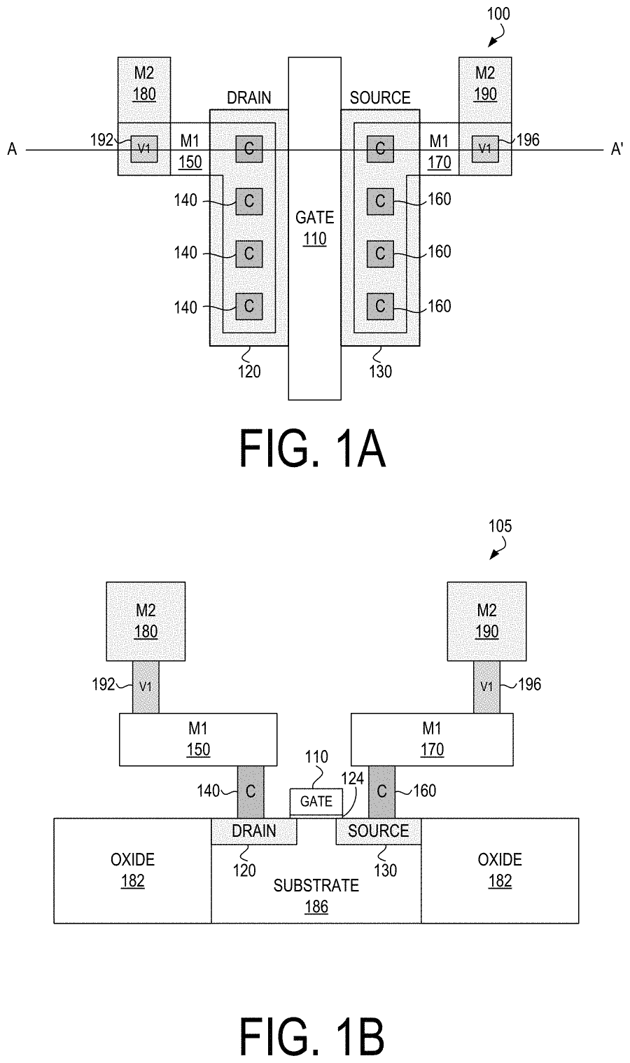

Turning now to FIGS. 1-3, an overview of various aspects of semiconductor device manufacturing is presented. FIG. 1A illustrates the physical design of an exemplary planar transistor. As will be discussed in greater detail below, the physical design of a transistor is used to generate the photomasks that will be used during manufacturing to print the features on a wafer needed to implement a design. The physical design is typically a set of polygons drawn at various layers, such as a gate layer, contact layer, and metal-1 layer.

Transistor 100 is a field-effect-transistor (FET), the transistor type that comprises the bulk of transistors used in modern semiconductor devices. Transistor 100 comprises gate 110, drain 120, and source 130 regions. The gate region in a FET can be thought of as an “on-off” switch that controls the flow of current between drain and source regions. When gate 110 is “off”, there is no (or little) current flowing through a channel region that connects drain 120 to source 130 and when gate 110 is “on”, current readily flows through the channel region. Transistor 100 is connected to other transistors by a set of interconnect layers stacked vertically on top of transistor 100. Contacts 140 connect drain 120 to segment 150 of a first metal layer (M1), and contacts 160 connect source 130 to M1 segment 170. M1 segments 150 and 170 are in turn connected segments 180 and 190 of a second metal layer (M2) by a first layer of “vias” (V1) 192 and 196, respectively. In general, metal layer thicknesses increase as one moves up the interconnect stack, with thinner lower-level metals being generally used for the local routing of signals and thicker upper-level metals being used for global signal routing and power/ground planes. For simplicity, FIG. 1A shows only two levels of metal. Current semiconductor manufacturing processes have up to ten layers of metal interconnects.

FIG. 1B illustrates an exemplary cross-section of the planar transistor of FIG. 1A taken along the line A-A′. Cross-section 105 shows gate 110 separated from drain 120 and source 130 regions by high-k dielectric layer 124, which electrically insulates gate 110 from drain 120 and source 130. Transistor 100 is in substrate region 186 and is insulated from adjacent transistors by oxide regions 182. The planar transistor illustrated in FIGS. 1A and 1B is just one type of transistor topography, the planar nature of the transistor reflecting that the gate, source, and drain regions are located on or are adjacent to a relatively planar surface. Another type of transistor topography is the non-planar transistor topography used in FinFETS, which are used extensively in modern manufacturing processes. FinFETS are field-effect transistors that operate under the same general principle as planar FET transistors—a gate controls the flow of current between drain and source regions—with the variation that the gate wraps around a set of fins that extend vertically upwards from the wafer surface.

Essential to semiconductor manufacturing is the process of photolithography, by which patterns are transferred from a photomask onto a wafer. As previously mentioned, photomasks are used to define the shape and location of various features to be patterned on a wafer for a given process layer. For example, one photomask defines where oxide regions are located, another photomask defines where high-k dielectrics will be located, another photomask defines the location of source and drain regions, and yet another photomask defines where contacts will be placed. Additional photomasks are used to define each metal layer and intervening via layers.

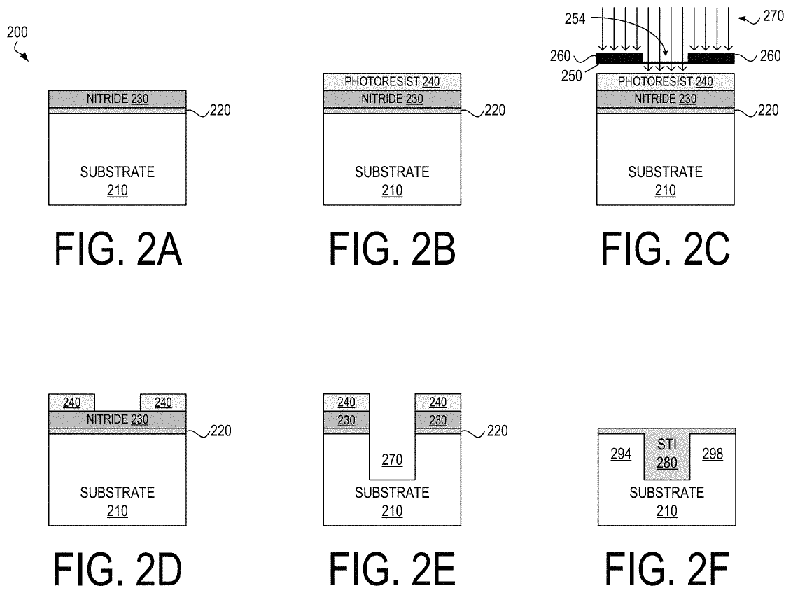

FIGS. 2A-2F illustrate an exemplary photolithography process. Process 200 is a simplified version of an actual photolithography process used in manufacturing, which contains more steps than those illustrated in FIGS. 2A-2F. Process 200 illustrates how the oxide regions 182 in FIG. 1B can be defined using photolithography. In FIG. 2A, a thin silicon dioxide layer 220 is thermally grown across the top of silicon substrate 210 of a wafer. Silicon nitride layer 230, a protective layer, is deposited on top of silicon dioxide layer 220. In FIG. 2B, photoresist 240 is deposited on top of nitride layer 230. A photoresist is a material whose reactance to an etchant or solvent increases (if a positive photoresist) or decreases (negative photoresist) upon exposure to light. In process 200, photoresist 240 is a positive photoresist. In FIG. 2C, photomask 250 with patterns 260 is positioned over the wafer and exposed to light 270. The light 270 passes through transparent region 254 of photomask 250 and exposes the underlying regions of photoresist 240. Patterned regions 260 are opaque to light 270 and the photoresist regions under patterns 260 are not exposed. In FIG. 2D, photoresist 240 is chemically developed and the exposed regions are dissolved. The remaining portions of photoresist 240 can now act as an on-wafer mask to allow for selective processing of the wafer. In FIG. 2E, the wafer is subjected to an etch step that removes a portion of the silicon nitride layer 230, silicon dioxide layer 220, and substrate 210 to create trench 270. In FIG. 2F, the photoresist and nitride layers are removed, and trench 270 is filled with silicon dioxide to create shallow trench isolation (STI) region 280 that serves to keep transistors formed in regions 294 and 298 electrically isolated from each other.

As masks are the means by which features are realized in semiconductor devices, any semiconductor device design must ultimately be reduced to a physical design, the level of design abstraction from which photomasks are generated. The physical design of a transistor (such as FIG. 1A), circuit, or processor to be manufactured is often referred to as a “layout.” Electronic design automation (EDA) tools allow processor architects and circuit designers to design at levels of abstraction above the physical design level. They are thus spared from having to spend their days drawing polygons in layout tools to realize their designs. Architects typically define their designs using a hardware design language (HDL), such as VHDL or Verilog. Once they have verified that their designs perform as desired, a physical design can be automatically generated using a library of standard layout cells. Circuit designers often seek performance or functionality not available using standard cells and often enter their designs into a schematic capture tool. Once their custom designs are finalized, the circuit schematics are handed off to layout designers who manually craft the custom physical designs.

Regardless of whether a physical design is generated automatically or manually, it must conform to a set of layout design rules established for a manufacturing process. Design rules are constraints that a physical design must follow to ensure manufacturability. Most design rules express a minimum width or space for a feature, such as, “gate length≥10 nm,” “source/drain diffusion enclosure of a contact≥16 nm,” and “space between metal-1 traces≥20 nm.” Design rules represent a trade-off between feature density and manufacturability. Being able to print smaller feature sizes can mean more die can be packed onto a wafer but if the process cannot reliably print the smaller features, the resulting reduction in wafer yield can more than offset cost reductions gained by being able to print more die on a wafer.

Developing design rules for a new process can be difficult as unexpected difficulties can arise. For example, a feature may not scale as much as expected from the previous technology generation due to unforeseen difficulties with a new processing step or a new tool. As process engineers develop a new manufacturing process, they continually fine-tune the individual processing steps to remove as many defect sources as possible. At some point, the process has been tuned enough that the remaining defects that need to be rooted out occur so infrequently that they are difficult to find. Process engineers need to find the occurrence of these rare events during process development so that they can determine whether a tweak to the process can be figured out to reduce the occurrence of the rare event, or to add a design rule to the design rule set so that physical design geometries and patterns correlated to a specific defect are kept out of the final physical design.

Once a physical design is clear of design rule violations and has passed other design validation checks, it is passed to the photomask generation phase of an EDA flow. The photomask generation phase is far from trivial due to the large discrepancy between the wavelength of the light (λ=193 nm) that has been used since the 90 nm technology node and the minimum feature sizes (10 nm, 7 nm) used in current processes. The minimum feature size that can be printed clearly in a photolithographic process is limited by the wavelength of the light source used and the semiconductor industry has developed resolution enhancement technologies (RET) to allow for the printing of features well below the 193 nm light source wavelength. A first set of RET techniques works to increase resolution and/or depth of focus, and a second set compensates for distortion effects due to printing features with a wavelength larger than minimum feature sizes as well as those inherent in deposition, etching, and other process steps. The first set includes techniques such as phase-shift masks and double-patterning, and the second set includes optical proximity correction (OPC).

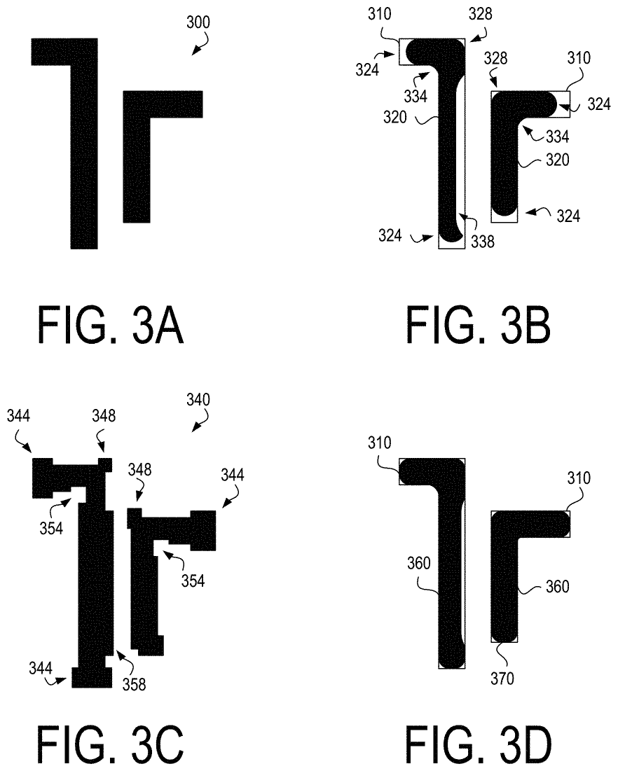

FIGS. 3A-3D illustrate differences between features on a photomask and those manufactured on a wafer due to process distortion effects and the use of optical proximity correction to counter those effects. FIG. 3A illustrates two gate polygons 300 in a physical design before being subjected to an OPC process. FIG. 3B illustrates a simplified view of how polygons 300 may appear as processed on a wafer. Outlines 310 represent the boundaries of polygons 300 and shapes 320 represent the corresponding as-processed features. It can be seen that ends 324 and exterior corners 328 of shapes 320 are rounded off, interior corners 334 are filled in, and segment 338 narrowed due to the presence of a nearby feature. FIG. 3C illustrates exemplary modified polygons 340 generated by subjecting polygons 300 to an OPC process. Modified polygons 340 are much more complex than original polygons 300. Modified polygons 340 include “dog-bone” features 344 that compensate for end-rounding, “ear” features 348 that compensate for exterior corner-rounding, “mouse-bite” features 354 that compensate for interior corner-rounding, and thickening features 358 that compensate for the presence of nearby features. FIG. 3D illustrates a simplified view of how modified polygons 340 may appear on a wafer after processing. Outlines 310 again represent the boundaries of original polygons 300. As can be seen, modification of polygons 300 by the OPC process results in printed shapes 360 that are closer to the shape and size of original polygons 300. The ends and corners of shapes 360 are less rounded off, the interior corners are less filled in, and the impact of nearby neighbors is diminished.

While OPC generation (and other RET techniques) have allowed minimal features to scale with technology node as the wavelength of the photolithographic light source has remained constant, it does not come without its costs. OPC generation is computationally intensive. OPC recipes can be based on physical models of various processing steps (photolithography, diffusion, etch, deposition, etc.), or be rule-based models that generate OPC features based on individual physical design feature characteristics (width, length, shape, nearest-neighbor characteristics) without relying on the physics of the underlying process steps. The application of model-based OPC recipes to a complete physical design may involve the application of physical models to over 10 billion shapes at the gate layer alone and to billions of additional shapes on other layers. Further, the generation of rule-based OPC models, which may save some of the computational complexity of model-based OPC generation, can be a complex affair. Generation of rule-based OPC recipes can be based on trial-and-error due to a lack of full understanding of the complex physics and chemistries at play in the development of cutting-edge processing technologies. This trial-and-error can comprise iteratively manufacturing features with many variations of candidate OPC recipes and seeing which recipes produce the best results.

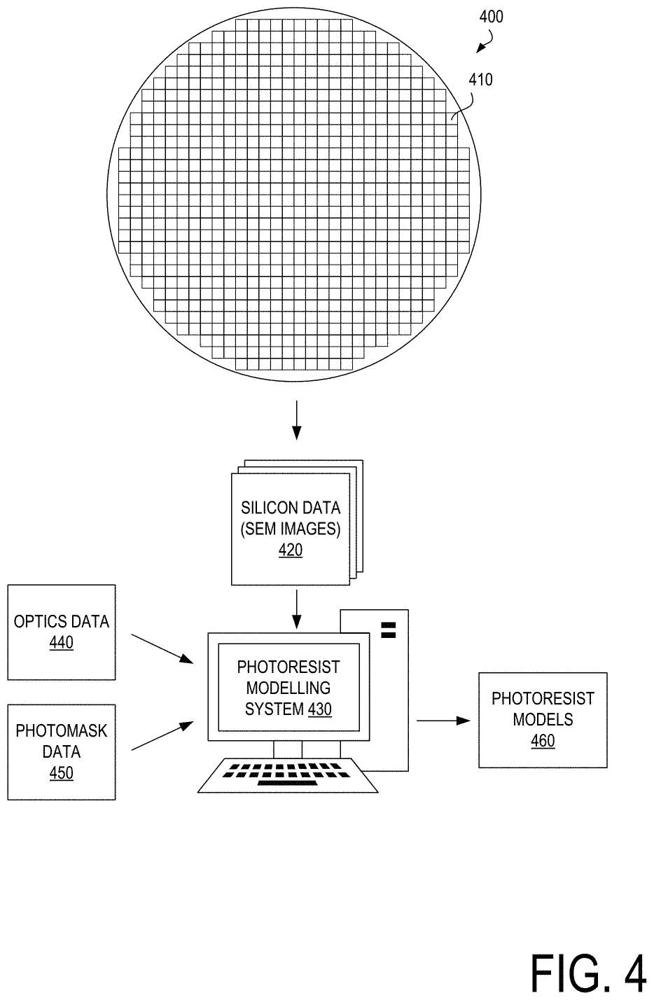

FIG. 4 illustrates an embodiment of silicon data capture and utilization of silicon data to aid semiconductor manufacturing process development. Silicon wafer 400 comprises dies 410. As discussed earlier, current technology nodes employ 300 mm wafers, which can comprise hundreds of dies. The dies are separated by scribe lines that can contain test structures that can be used to monitor the health of manufacturing process and that are consumed by the dicing process, where wafer 400 is cut into individual dies 410. During the manufacture of silicon wafer 400, silicon data 420 can be generated that can be used for the development of a new process or to monitor the health of a mature one. Silicon data 420 can be any data collected during the manufacturing of wafer 400, including SEM (scanning electron microscopy) images, TEM (transmission electron microscopy) images, and diagnostic data. Diagnostic data can include data collected from the scribe line test structures, which can measure electrical properties of varies features or layers (e.g., contact or via resistance, metal layer sheet resistance), or indicate the presence of manufacturing defects by testing for shorts between, for example, gate or metal structures that reflect minimum features or layout patterns of concern.

Any number of SEM images can be generated during the manufacturing of a wafer. SEM images can be taken of one or more areas of interest on an individual die for various die on a wafer. For example, SEM images may be taken of the gate layer in a region where the gate patterns are particularly dense (such as in a memory array) and for representative dies across the wafer to capture cross-wafer manufacturing variations. SEM images can be taken at any point in the manufacturing process. As SEM images can capture a field of view that is hundreds of microns in length and width, individual images can contain many instances of minimum features or areas of interest.

Silicon data 420 can be generated for wafers processed during process development or monitoring and can be generated for wafers processed across fabrication facilities to evaluate cross-facility manufacturing robustness. Given today's large wafer sizes, process complexities, and wafer run rates, the amount of silicon data that can be produced during process development or monitoring can be tremendous. The number of SEM images generated during process development alone can reach into the millions.

As will be discussed in further detail below, photoresist modeling system 430 takes silicon data 420, optics data 440, and photomask data 450 as input to develop photoresist models 460.

Being able to accurately model semiconductor manufacturing processing steps is important for process development. Having models that accurately model the photolithography process is particularly important. Such models can assist process development engineers in identifying features or geometries causing yield problems and in developing new OPC recipes and OPC features for a new technology. Photoresist models that can accurately predict photoresist contours quickly can also help by reducing process development time. The ability to quickly develop accurate semiconductor manufacturing process models is also important. Photoresist models used in older technology nodes may not be sufficiently accurate for use in current ones and new photoresist models may need to be developed. The artificial intelligence techniques described herein to develop fast and accurate photoresist models can allow for the quick generation of photoresist models over other approaches.

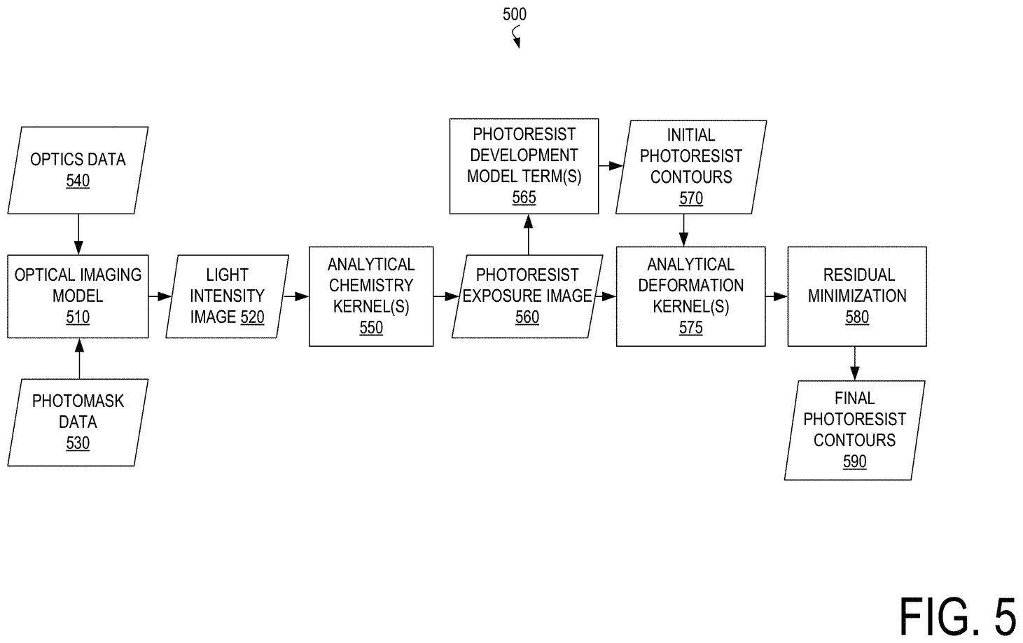

FIG. 5 illustrates an exemplary photoresist model. Model 500 is a multi-stage model, the first stage of which comprises optical imaging model 510 that generates light intensity image 520 from input photomask data 530 and optics information 540. Photomask data 530 represents all or a portion of a photomask and can contain OPC features, such as those illustrated in FIG. 3C. Optics data 540 comprises values for optical parameters in optical imaging model 510 that reflect the photolithography process being modeled. Optics data 540 can include the wavelength of the light that the photoresist will be exposed to, the exposure dose that the photoresist will receive, photolithography tool (e.g., steppers) settings, etc. Optical imaging model 510 simulates the interaction of light coming from a light source with a photomask and optical elements (lenses, etc.) of the photolithography tool to generate light intensity image 520. Light intensity image 520 represents the predicted light intensity falling across an area of photoresist patterned by a photomask represented by photomask data 520. Optical imaging model 510 is a parameterized model and, as will be discussed in detail later, optical imaging model parameters are selected for calibration during an iteration of the reinforcement learning methods described herein. Example optical imaging model parameters include pole configuration of the light source, photomask transmission, absorption and mask corner-rounding parameters, lens pupil intensity profile, lens numerical aperture adjustment, stepper focus offset and illumination dose adjustment.

The second stage of model 500 comprises one or more analytical chemistry kernels 550 that take light intensity image 520 and generate photoresist exposure image 560, which represents light exposure levels across an area of photoresist. Analytical chemistry kernels 550 simulate photochemical reaction and diffusion processes that occur in an area of photoresist resulting from the photoresist being exposed to the light intensities represented by light intensity image 520 and subjected to a post-exposure bake step (a step not illustrated in the simplified photolithography process illustrated in FIGS. 2A-2F). In some embodiments, analytical chemistry kernels 550 can model additional physical and chemistry processes that may play a factor in determining the levels of light exposure across an area of photoresist.

In some embodiments, analytical chemistry kernels 550 and analytical chemistry deformation kernels 575, which will be discussed in greater detail below, model physical phenomena occurring in the photoresist during the photolithography process such as acid degeneration, de-protection, diffusion, cross-linking, de-gassing, photoresist development, and shrinkage. As such, the model physical and chemical processes that may not be comprehended by existing compact fast photoresist models. In some embodiments, each kernel models a separate physical or chemical process.

The analytical kernels can be derived from analytical mathematical solutions of equations that rigorously model photoresist processes. As used herein, the term “kernel” refers to a mathematical function representing a mathematical solution for an equation. When the function is combined with specific boundary conditions representing a physical system modeled by the equations, it gives the particular solution for that specific system. For example, the analytical chemistry kernels can be convolution functions such as a Gaussian that when convolved with a particular lithographic intensity image give the resulting concentration of chemicals in the photoresist due to reaction and diffusion processes.

Analytical kernels may be derived exactly for simple photomask geometries and can be a function of local and far-field properties of the lithographic intensity profile and photoresist properties such as reaction and diffusion coefficients, development rates, and initial height. In some embodiments, the analytical kernels are two-dimensional compact photoresist models that predict the top-down view of photoresist boundaries in the form of two-dimensional contours. In some embodiments, the analytical chemistry kernels can be derived by modeling the photoresist as a linear elastic material that shrinks in proportion to the amount of lithographic exposure and analytically solving the equations for conservation of momentum and mass for simple photoresist contour shapes representing un-deformed photoresist profiles. In some embodiments, model 500 applies analytical kernels to a region of photoresist by breaking down the modeled photoresist into local geometries or chunks for which the solution is known. Solutions for the local geometries are stitched together using a patching algorithm to come up with solutions for arbitrary geometries.

In some embodiments, the analytical kernels included in a photoresist model can be selected from a set of analytical kernels that have been derived for a technology. This set derived kernels can comprise multiple kernels that model an aspect of photoresist physics or chemistry or photoresist deformation in alternative manners. As will be discussed in greater detail below, photoresist model 500 can be calibrated to include only those kernels that are the most useful in generating accurately predicted photoresist contours.

Like optical imaging model 510, analytical chemistry kernels 550 are parameterizable and analytical chemistry kernel parameters are selected to be calibrated during photoresist model calibration. Example analytical chemistry kernel parameters include reaction and diffusion model parameters for chemically amplified resists (CAR) such as acid production rate as a function of the local intensity, acid diffusion length as a function of intensity, acid loss rates, and photoresist polymer de-protection rate as a function of the local acid concentration after acid loss and diffusion. The level of polymer de-protection determines how much of the photoresist will be washed away in the development stage.

The third stage of photoresist model 500 comprises one or more photoresist development model terms 565 that operate on photoresist exposure image 560 to generate initial photoresist contours 570. Photoresist development model terms 565 calculate a development threshold level for every point in photoresist exposure image 560 and segments the exposure image into regions where the photoresist is either washed away or remains after development. The boundaries of the regions where the photoresist remains are denoted using a set of contours, which define initial photoresist contours 570. In some embodiments, photoresist development model terms 565 can be taken from existing compact fast photoresist models. Like other stages in photoresist model 500, photoresist development model terms 565 are parameterized and model term parameters can be selected to be calibrated during photoresist model calibration.

The fourth stage of photoresist model 500 comprises one or more analytical deformation kernels 575 that operate on photoresist exposure image 560 and initial photoresist contours 570 to model deformation of initial photoresist contours 570. Analytical deformation kernels 575 capture photoresist shrinking and deformation that can occur during the post-exposure bake, processes that may not be captured by photoresist development model terms 565. Model 500 applies the analytical deformation kernels by breaking down the undeformed photoresist contours in initial photoresist contours 570 into smaller chunks for which solutions are known. Solutions for the individual chunks are then stitched together with the patching algorithm to come up with deformed photoresist contours for arbitrary photoresist contour geometries.

Like analytical chemistry kernels 550, the individual analytical deformation kernels are parameterized and analytical deformation kernel parameters can be selected for calibration during photoresist model calibration. Example analytical deformation kernel parameters include nominal photoresist shrinkage amount, photoresist elasticity, and distance scaling for photoresist shrinkage effects, coefficients for local boundary shape attributes, and coefficients for geometric measures of neighboring contours.

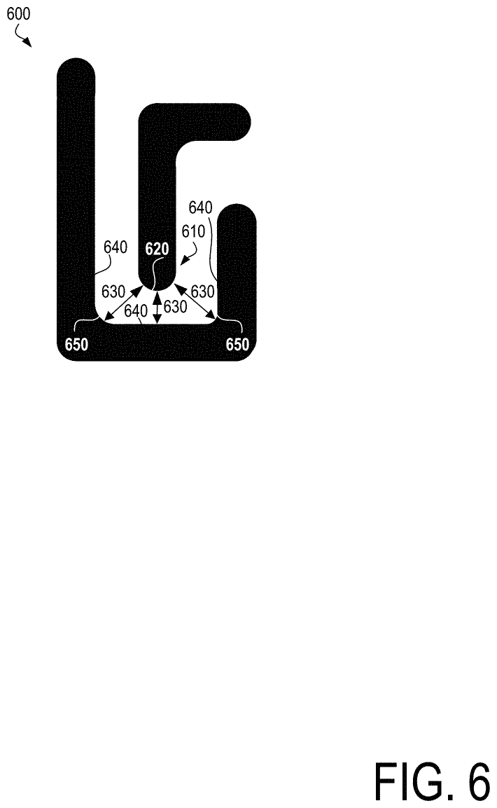

One manner in which analytical deformation kernels 575 are parameterized is that they are a function of local photoresist contour curvature and photoresist imaging properties, the distance to neighboring contours, neighboring contour curvatures, and neighboring image properties. For example, with reference to FIG. 6 (which illustrates exemplary predicted photoresist contours 600 after photoresist development), an analytical deformation kernel for determining photoresist deformations in endcap features can factor in the following to determine the deformation of endcap feature 610: curvature 620 of endcap 610, distances 630 between endcap 610 and neighboring contours 640, and curvatures 650 of neighboring contours 640. In some embodiments, the analytical deformation kernels can be a function of additional photoresist contour and photoresist exposure image properties or characteristics. In some embodiments, a ray-shooting algorithm can be used for finding neighboring photoresist contours and neighboring photoresist contour properties for a contour for which deformation is to be determined.

The output of analytical deformation kernels 575 is a set of deformed photoresist contours. Residual minimization 580 can be applied to the deformed photoresist contours to correct for systemic residual errors in photoresist model 500, as will be discussed in greater detail below. Residual minimization 580 produces final photoresist contours 590, which represent predicted photoresist contours that will be printed on a wafer during manufacturing using the photolithography process modeled by photoresist model 500 for an area on the wafer corresponding to photomask data 520. In some embodiments, residual minimization is not applied to the deformed photoresist contours generated by the analytical deformation kernels and the deformed photoresist contours generated by analytical deformation kernels 575 are the final photoresist contours.

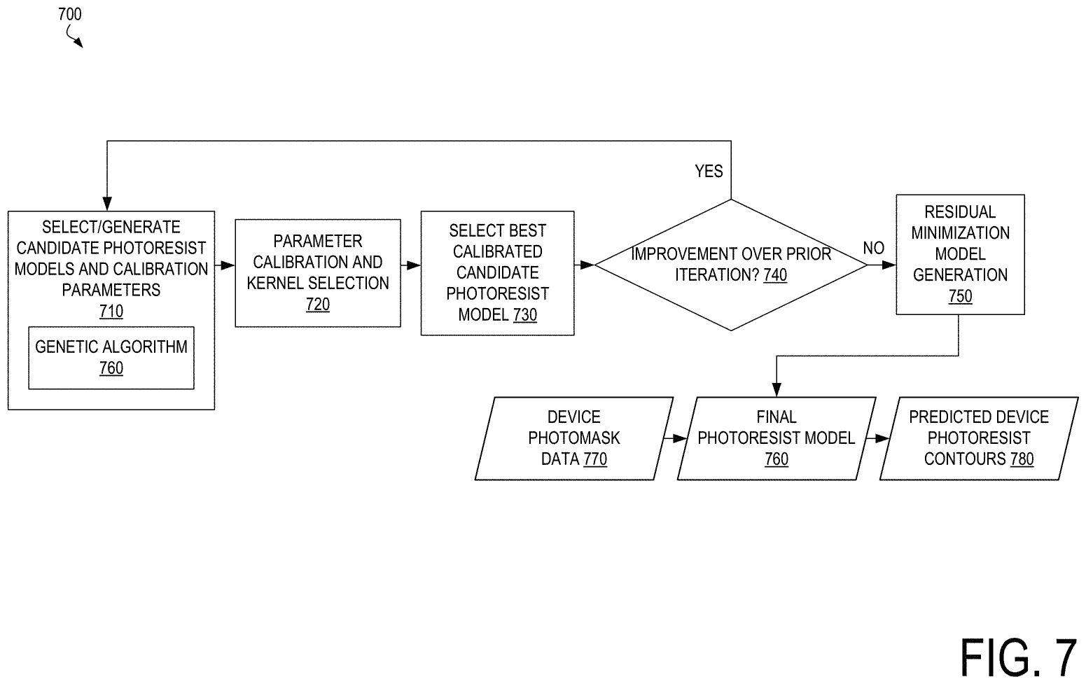

FIG. 7 illustrates an exemplary reinforcement learning method for developing a photoresist model. Method 700 comprises iteratively determining a set of candidate photoresist models, calibrating each of those models so that they match photoresist contours extracted from SEM images as closely as possible, and using a genetic algorithm to determine a set of candidate photoresist models for the next iteration based on the most accurate candidate photoresist model generated in the current iteration. The iterations cease once the best candidate photoresist model of the current iteration does not predict photoresist contours any better than the best candidate photoresist model of the previous iteration. The best candidate photoresist model of the last iteration becomes the final photoresist model and a residual minimization model can be developed to correct for systemic residual errors that may exist in the final photoresist model.

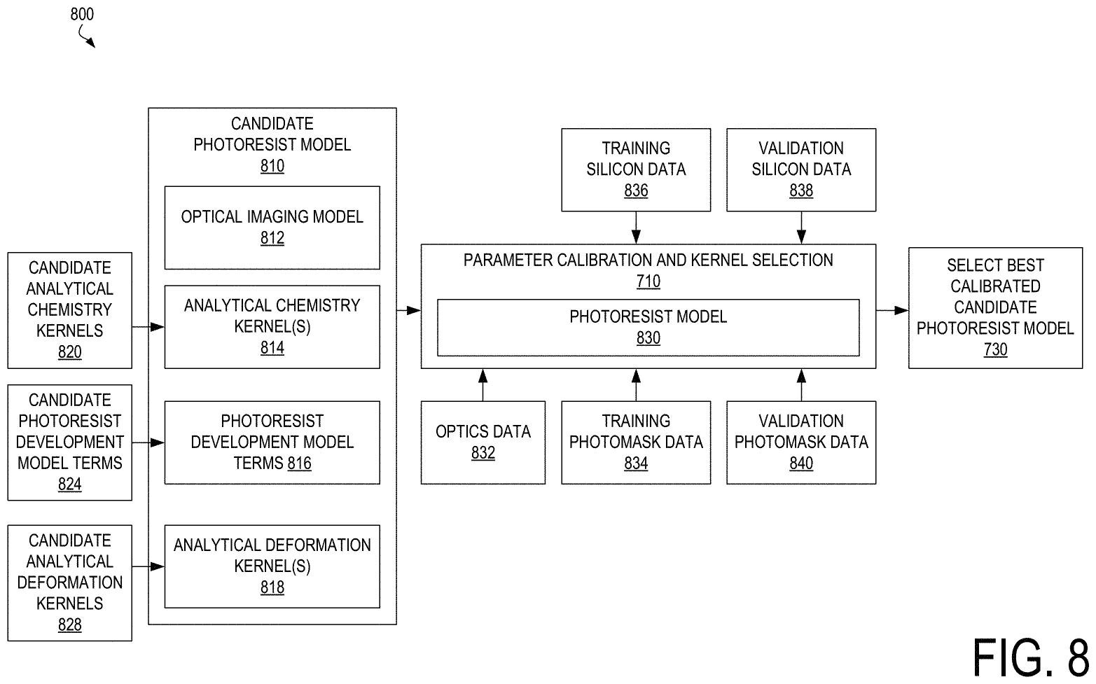

In an initial iteration of method 700, a set of initial candidate photoresist models and model parameters to be calibrated for each of the initial candidate photoresist models are selected at stage 710. With reference to FIG. 8, which illustrates an exemplary iteration and additional details of method 700, candidate photoresist model 810 comprises optical imaging model 812, one or more analytical chemistry kernels 814, one or more photoresist development model terms 816, and one or more analytical deformation kernels 818. Analytical chemistry kernels 814 can be selected from candidate analytical chemistry kernels 820, photoresist development model terms 816 can be selected from candidate photoresist development model terms 824, and analytical deformation kernels 818 can be selected from candidate analytical deformation kernels 828. In some embodiments, candidate analytical kernels 820 and 828 are a set of analytical kernels derived for a technology. In some embodiments, candidate photoresist development model terms 824 belong to a compact fast photoresist development model for an existing technology. The analytical kernels and photoresist development model terms included in the initial candidate photoresist models can be selected randomly, belong to a set of pre-defined kernels and model terms to be included in the initial candidate photoresist models, or be selected in another manner. In some embodiments, candidate analytical chemistry kernels 824 and analytical deformation kernels 828 contain kernels that are cross-terms of derived kernels to account for higher-order effects.

Returning to FIG. 7, stage 710 selects the calibration model parameters for each candidate photoresist model, the model parameters that are to be calibrated in an iteration of method 700. One set of photoresist model parameters relates to the form of a photoresist model and how the individual models, model terms, and kernels in a model are scaled. In some embodiments, multiple model forms can be considered in the same iteration. A candidate photoresist model can take various forms, such as a multi-stage model or a mixed model. FIG. 5 illustrates a multi-stage model that comprises a series of stages that model different photoresist processes applied in a stepwise manner. In a mixed model, the photoresist model terms and kernels are applied simultaneously. In either model type, the individual models, model terms, or kernels that comprise a candidate photoresist model can be parameterized with linear parameters and/or non-linear parameters such that individual terms or kernels are scaled linearly or non-linearly during calibration. For example, an individual candidate photoresist model can include a photoresist development model term f(x₁ . . . xₙ), (where x₁ through xₙ are the inputs to the model term) in the form A*f(x₁ . . . xₙ). A is a linear parameter that can be selected for calibration in an iteration of method 700 and allows for the photoresist development model term f(x) to be scaled linearly during calibration. A candidate photoresist model can also be of a form wherein individual models, model terms, or kernels are parameterized to be scaled non-linearly during calibration of the candidate photoresist model. For example, an analytical kernel k(y₁ . . . yₙ) (where y₁ through yₙ are the inputs to kernel k) can be represented in a photoresist model as a power function having the form k(y₁ . . . yₙ)^{B}, with B being a non-linear parameter that allows for kernel k to be scaled non-linearly during calibration. Models, model terms, and kernels can be modeled in other non-linear fashions such as with exponential functions, logarithmic functions, polynomial functionals, Gaussian functions, etc., any of which can be parameterized to allow non-linear scaling of the kernel during model calibration.

A candidate photoresist model can contain both linearly and non-linearly parameterized models, model terms, and kernels. For example, a candidate photoresist model could comprise an optical imaging model that is linearly parameterized, six analytical chemistry kernels (three of which are linearly parameterized and three of which are non-linearly parameterized), a set of photoresist development model terms that are linearly parameterized, and five analytical deformation kernels that are non-linearly parameterized.

One or more of the linear or non-linear model parameters can be selected for calibration in an iteration of method 700. Model parameters not selected for calibration in an iteration of method 700 can have values from a prior iteration, values based on calibrated values from a prior iteration, pre-defined values, or values determined in another manner. In the immediately preceding example, the linear parameters of the optical imaging model and the non-linear parameters of the three non-linearly modeled analytical chemistry kernels are selected for calibration. The other linear and non-linear parameters are set to calibrated values determined in prior iterations of method 700.

The models, model terms, and kernels in each candidate photoresist model are further parameterized in that they that are a function of the equipment and photoresist material used in the photolithography process, the photomask data, and the images generated by the various stages of the photoresist model. Several all these parameters have already been discussed (e.g., pole configuration of the light source, lens pupil intensity profile, photomask corner-round parameters, curvature of local photoresist contour, distance to near-neighbor curvature, diffusion coefficients). As these parameters do not relate to the scaling of individual models, model terms, or kernels, these parameters are not selected for calibration during iterations of method 700.

After selection or generation of the candidate photoresist models and the selection of calibration model parameters for the individual models, method 700 progresses to parameter calibration and kernel selection stage 720. In this stage, supervised learning algorithms drive parameter calibration and kernel selection by fitting the candidate photoresist model to training photoresist contours extracted from SEM image data. That is, the supervised learning algorithms drive parameter calibration and kernel selection based on how well a candidate photoresist model predicts photoresist contours as compared to photoresist contours extracted from SEM images taken during manufacturing. Kernel selection comprises selecting the kernels that are the most useful in accurately predicting photoresist contours. These “most useful” analytical kernels are those that are the most determinant in accurately predicting photoresist contours. For example, consider a candidate photoresist model containing nine analytical kernels prior to calibration. The technologies described herein can identify four kernels as the most useful kernels and keep those four kernels in the calibrated candidate photoresist model if including any of the remaining kernels do not provide any additional predictive accuracy or not enough predictive accuracy to justify incurring the cost of adding the kernel to the model (e.g., risk of over-fitting, a more complex model).

In some embodiments, method 700 simultaneously starts multiple threads with different selections of calibration model parameters. Some parameters are always selected such as stepper focus offset and illumination dose adjustment while others can be optionally selected. Each thread continues to have children models until the thread converges.

The supervised learning algorithms used for parameter calibration and kernel selection in stage 720 use photoresist model 830 and the training datasets shown in FIG. 8. In some embodiments, photoresist model 830 can be photoresist model 500. Photoresist model 830 uses optics data 832 as input (which can be optics data 530) and the photoresist models are calibrated using training photomask data 834 and training silicon data 836. Training silicon data 836 (along with validation silicon data 838) can be photoresist contours extracted from SEM images taken during wafer manufacturing using a photomask generated at least in part with training photomask data 834.

Various artificial intelligence algorithms can be used to calibrate the candidate photoresist models to best fit the silicon data. These include regression models, artificial neural networks, decision trees, genetic algorithms, and support vector machines. The various regression approaches can include stepwise regression with sensitivity analysis, lasso or elastic-net based regularized regression, and ridge regression, and the total weighted mean-squared error between predicted photoresist contours and photoresist contours extracted from SEM images can serve as the regression cost. In some embodiments, principal components analysis and statistical correlation approaches can be used for kernel selection.

In some embodiments, convolutional neural networks (CNN) are used for parameter calibration and kernel selection. In a CNN-based approach, neurons of the CNN are linked to the optical imaging model, the analytical chemistry kernels, the photoresist development model terms, and the analytical deformation kernels. The CNN takes candidate photoresist model parameters as input and generates predicted photoresist contours as output. Minimization of the error between the predicted photoresist contours and the photoresist contours in training silicon data 836 drives training of the CNN model using CNN training techniques. Kernel selection is done by selecting the analytical kernels linked to the most activated neurons (i.e., those having the greatest neuron coefficients) in the neural network.

As previously stated, having fewer analytical kernels in photoresist model can prevent over-fitting and can result in a more predictive and compact model. Models with fewer analytical kernels have the further advantage of being able to be trained on fewer data. Various statistical techniques can be used to determine which kernels are the most useful kernels, such as dimensionality reduction and statistical correlation algorithms. In some embodiments, a massively parallel computing flow can be used to calibrate the candidate photoresist models simultaneously.

The result of stage 720 is a set of calibrated candidate photoresist models. Each model comprises an optical imaging model, one or more photoresist development terms, and the analytical kernels that were deemed the most useful (analytical kernels not deemed most useful are not included in the calibrated model), and calibrated values for the calibration model parameters.

After calibration model parameters have been calibrated and the most useful kernels have been selected for each candidate photoresist model using training silicon 836 and training photomask data 834, each candidate photoresist model is cross-validated using validation silicon data 838 and validation photomask data 840. In some embodiments, the SEM images used for model training and cross-validation is taken from a single wafer with 70% of the SEM images being used for training and 30% being used for validation. In some embodiments, an exhaustive cross-validation approach is not used. Rather, the data is split to ensure that the locations are sufficiently varied to cover the different types of photoresist feature patterns that can occur in a semiconductor device. In some embodiments, a second stage of validation is performed using SEM data from a second wafer manufactured under the same photolithography conditions as the first wafer. Adjustment of the model parameters is allowed for a few selected optical parameters that have expected slight variations between different wafers, but all other model parameters are kept the same and the accuracy of the candidate photoresist models in predicting photoresist contours extracted from the second wafer SEM images is determined. A calibrated photoresist model is considered validated if it is as accurate in predicting photoresist contours from the second wafer as it is in predicting photoresist contours from the first wafer, or if its predictive accuracy is within an acceptable range.

The calibrated candidate photoresist model that most accurately predicts photoresist contours from among the models in an iteration is determined at stage 730. In some embodiments, the accuracy of a candidate photoresist model is based on how well it predicts photoresist contours for both training and validation data sets. In some embodiments, the accuracy of a candidate photoresist model is determined by a set of objectives to be minimized based on accuracy requirements for different types of photoresist geometries. For example, the accuracy requirement for geometries having a high printed feature density greater could be greater than the accuracy requirement for geometries having a low printed feature density. In some embodiments, stage 730 uses an unsupervised learning algorithm, such as k-means clustering, Gaussian mixture models, or neural network-based self-organizing maps to select the best calibrated candidate photoresist model.

After determining the best calibrated candidate photoresist model, method 700 proceeds to stage 740 to see if the best model of the current iteration is more accurate than the best candidate photoresist model from the previous iteration. If not, method 700 identifies the best candidate photoresist model from the previous iteration as the final photoresist model and proceeds to stage 750. In some embodiments, the best calibrated photoresist models of the last iteration are selected as the final photoresist model. If so, then another iteration of method 700 is performed. In other embodiments, different criteria can be used to decide whether method 700 should cease iterating. For example, method 700 may cease iterating if the best candidate photoresist model predicts photoresist contours in the training and validation silicon data within an error threshold. In some embodiments, the method may be allowed to iterate for several more iterations with different children models after the best candidate photoresist model of the current iteration is found to be no more accurate than the best candidate photoresist model of the prior iteration. If none of the best candidate photoresist models from these addition iterations yield a better model, the method is considered to have converged.

For second and later iterations of stage 710, the candidate photoresist models are determined by genetic algorithm 760. Genetic algorithm 760 generates a set of candidate photoresist models for the next iteration (“children models”) from the best candidate photoresist models from the previous iteration (“parent models”). Photoresist model properties are encoded as real values and cross-over and mutation operations of the genetic algorithm operate on these properties of parent models to generate a child model. In some embodiments, model properties are encoded as binary values and the cross-over and mutation operate on the binary values of parent models to generate a child model. A child model is generated from two parent models, and different child models are generated from different pairs of parent models. In some embodiments, at least some of the children models are generated from more than two parent models. In some embodiments, genetic algorithm 760 is a steady-state multi-modal algorithm in which the best calibrated candidate photoresist model from the previous iteration is kept as a candidate photoresist model for the next iteration.

Once the criteria for ceasing iteration of method 700 has been met, method 700 proceeds to stage 750, wherein a residual minimization model is developed based on the final photoresist model. In some embodiments, a residual minimization model is generated only if there are non-negligible errors between the photoresist contours predicted by the final photoresist model and the corresponding photoresist contours extracted from SEM images. These errors can be determined to be non-negligible if they exceed an error threshold, which can pre-determined or determined in some other manner. In some embodiments, the residual minimization model is a regularized artificial neural network that uses local SEM image samples as input, generates residual errors as output and is trained to reduce the residual errors. In other embodiments, other supervised learning methods can be used for residual minimization such as decision trees and support vector machines. Although residual minimization model generation 750 is shown as being outside of the genetic algorithm reinforcement learning loop due to its high computational expense, in some embodiments residual minimization can be included as part of candidate photoresist model calibration if sufficient computing resources are available. In such embodiments, residual minimization model generation 750 can be performed for the best calibrated candidate photoresist model of each iteration and the predictive accuracy for the best calibrated candidate photoresist model can include the residual minimization model. In some embodiments, a residual minimization model can be generated for each calibrated candidate photoresist model and the best calibrated candidate photoresist model for a given iteration can be determined including the residual minimization model for each calibrated candidate photoresist model.

Upon completion of residual minimization model generation 750, or upon completion of the last iteration of method 700 if no residual minimization model is generated, method 700 is considered to have generated final photoresist model 760. Final photoresist model 760 may or may not be considered to contain a residual minimization model. With final photoresist model 760 developed for a manufacturing process, it can be used to operate on device photomask data 770 to generate predicted device photoresist contours 790. Predicted photoresist device contours 780 can be used to aid process development by, for example, assisting product engineers in identifying photomask geometries that are responsible for yield reductions and generating new OPC recipes and features for a new technology.

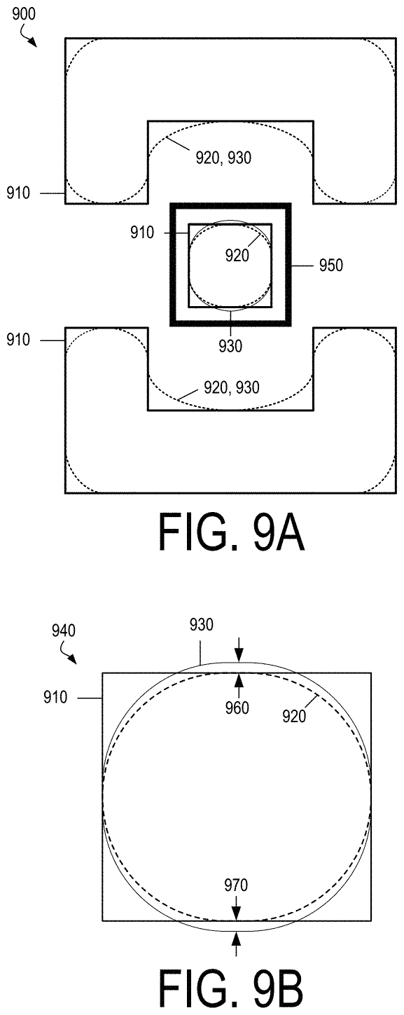

FIGS. 9A-9B illustrate photoresist contours for a target structure and corresponding photoresist contours predicted by existing photoresist models and a photoresist model developed using the technologies disclosed herein. Contours 900 and 940 comprise photoresist contours 910 for the target photoresist structure, contours 920 predicted by the existing photoresist model, and contours 930 predicted by a photoresist model generated using the technologies described herein. Contours 940 are a magnified version of contours 900 in region 950. Contours 920 and 930 show that the inclusion of analytical kernels that capture physical processes not comprehended in existing photoresist models can predict photoresist contours different from those predicted by existing models. In a real-world example corresponding to FIGS. 9A-9B, the contour difference was 3.179 nm for feature 960 and 3.132 nm for feature 970.

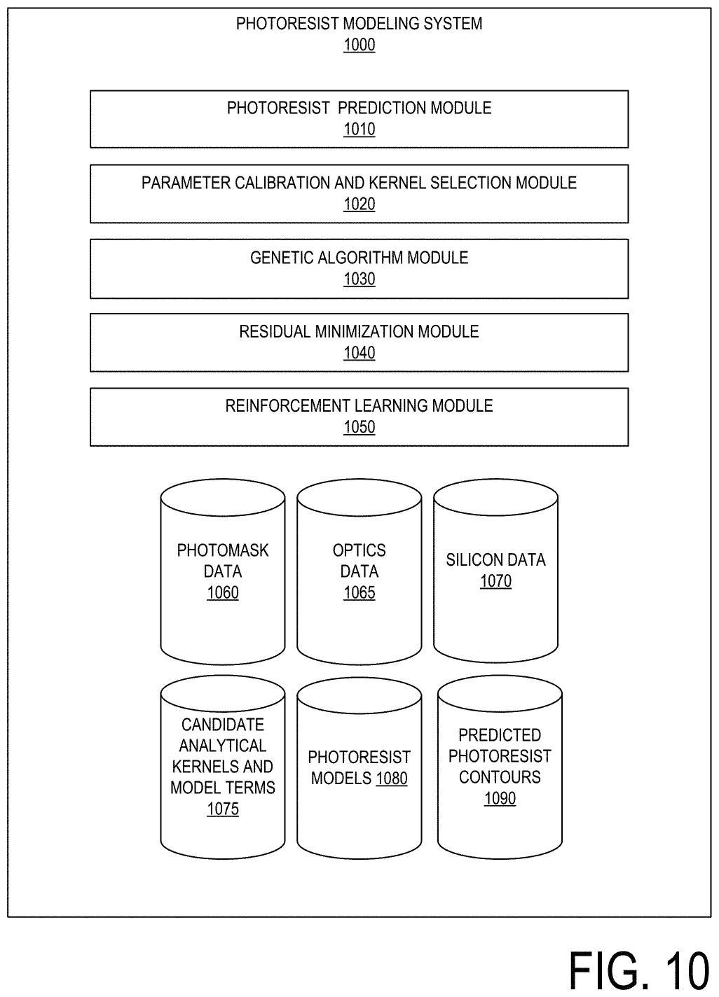

FIG. 10 is a block diagram of an exemplary photoresist modeling system. System 1000 comprises photoresist prediction module 1010, parameter calibration and kernel selection module 1020, genetic algorithm module 1030, residual minimization module 1040, and reinforcement learning module 1050. Photoresist prediction module 1010 can implement photoresist model 500 or any other model that can predict photoresist contours. Parameter calibration and kernel selection module 1020 can perform parameter calibration and kernel selection for a candidate photoresist model. In some embodiments, parameter calibration and kernel selection module 1020 can also determine the best calibrated candidate photoresist model from among a set of calibrated candidate photoresist models. Genetic algorithm module 1030 can implement one or more genetic algorithms that generate a set of candidate photoresist models for a next iteration of an iterative reinforcement learning method from one or more of the best calibrated candidate photoresist models from the previous iteration. Residual minimization model 1040 can generate a residual minimization module to correct for systemic errors in a photoresist model. Reinforcement learning module can handle tasks not handled by the other modules in system 1000 to implement the reinforcement learning methods described herein, such as determining an initial set of candidate photoresist models and determining whether a reinforcement learning method should continue iterating.

Photoresist modeling system 1000 also comprises memory or storage containing data operated on or generated by any of the illustrated modules. Photoresist modeling system 1000 can comprise photomask data 1060, optics data 1065, silicon data 1070, candidate analytical kernels and photoresist development model terms 1075, candidate and final photoresist models 1080, and predicted photoresist contours 1090.

It is to be understood that FIG. 10 illustrates one example of a set of modules that can comprise photoresist modeling system 1000. In other embodiments, photoresist modeling system 1000 can contain more, fewer, or different modules than those shown. In some embodiments, two or more of the modules shown in system 1000 can be combined into a single module, or a single module shown in system 1000 can be split into two or more modules. The modules shown in FIG. 10 can be implemented in software, hardware, firmware or combinations thereof and can be alternately referred to circuitry (e.g., “genetic algorithm circuitry,” “photoresist prediction circuitry”). A computer device referred to as being programmed to perform a method can be programmed to perform the method via software, hardware, firmware or combinations thereof.

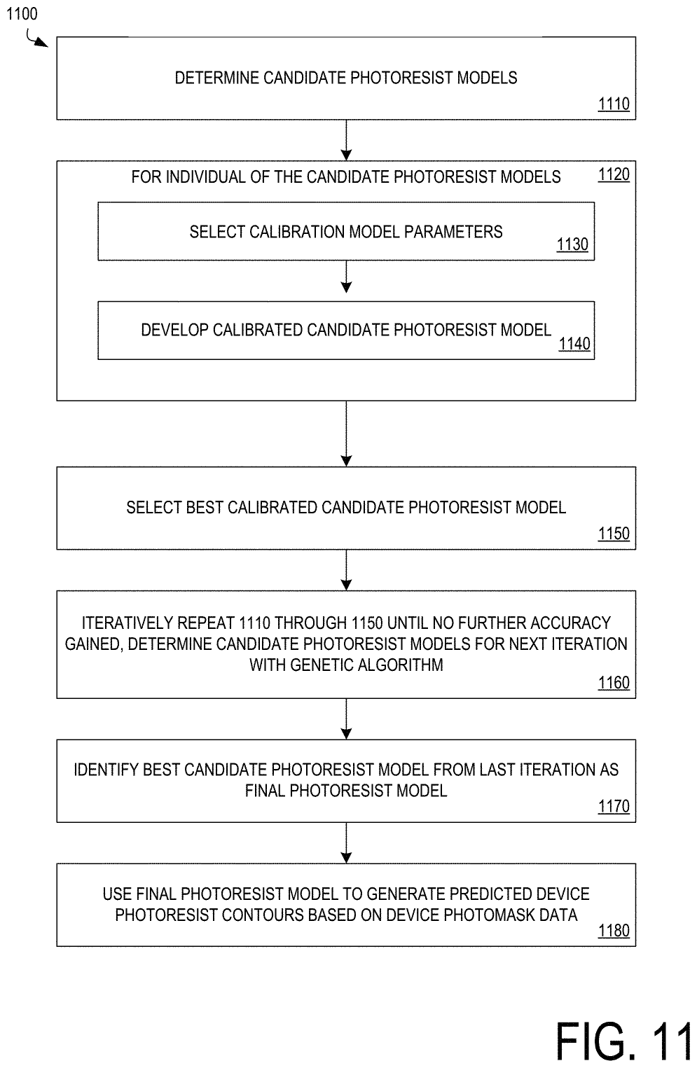

FIG. 11 is an exemplary reinforcement learning method for generating photoresist models. The method 1100 can be performed by, for example, the photoresist modeling system 1000. At 1100, a plurality of candidate photoresist models is determined. Each candidate photoresist model comprises an optical imaging model, one or more analytical kernels, and one or more photoresist development model terms. Each of the candidate photoresist models further comprises a plurality of model parameters associated with at least one of the optical imaging model, the analytical kernels, or the photoresist development models terms.

At 1120, 1130 and 1140 are performed for each candidate photoresist model. At 1130, one or more calibration model parameters are selected from the model parameters. At 1140, one or more supervised learning algorithms are used to develop a calibrated version of the individual candidate photoresist model by fitting the individual photoresist model to training photoresist contours extracted from SEM image data. The calibrated candidate photoresist model comprises calibrated values for the calibration model parameters and one or more useful analytical kernels. The useful kernels are more determinant in contributing to the predictive accuracy of the calibrated photoresist model than analytical kernels not identified as useful. The analytical kernels not identified as useful are not included in the calibrated individual candidate photoresist model.

At 1150, the calibrated candidate photoresist model that most accurately predicts the training photoresist contours and validation photoresist contours extracted from SEM image data is selected as the best calibrated candidate photoresist model.

At 1160, 1110 through 1150 are iteratively repeated until the best calibrated candidate photoresist model of a current iteration of 1110 through 1150 no more accurately predicts the training photoresist contours and the validation photoresist contours than the best calibrated candidate photoresist model of a prior iteration of 1110 through 1150. The plurality of candidate photoresist models determined in a next iteration of 1110 through 1150 is determined at least in part by a genetic algorithm operating on at least the best calibrated candidate photoresist model from the current iteration.

At 1170, the best calibrated candidate photoresist model from a last iteration of 1110 through 1150 is identified as a final photoresist model. At 1180 the final photoresist model is used to predicted device photoresist contours based on device photomask data.

In an example application of the technologies disclosed herein, a photoresist model for a 10 nm semiconductor manufacturing technology was developed. Dimensionality reduction algorithms such as principal components analysis and statistical correlation measures were used for kernel selection. A genetic algorithm-based calibration was used to calibrate the model parameters of the analytical kernels and artificial neural networks were trained to generate predicted deformed photoresist contours closely matching on-wafer photoresist contours. The final photoresist model successfully incorporated photoresist shrinkage effects into a fast photoresist model and yielded a 63% accuracy improvement on critical structures, while being predictive on validation datasets for a problematic processing layer.

The reinforcement learning technologies described herein to generate photoresist have advantages over existing approaches. Photoresist models developed using the technologies described herein are more accurate for advanced technologies as they include analytical chemistry kernels and analytical deformation kernels that model photoresist processes that are absent from existing photoresist models. Further, photoresist models developed using the technologies described herein are compact models owing to the inclusion of only the most useful analytical kernels. Thus, these models can be fast as well as accurate. Moreover, the artificial intelligence approaches and techniques described herein allow photoresist models to be developed more quickly than those developed using other approaches. The quick generation of compact, fast and accurate photoresist models can help reduce process development time, not only by reducing the time it takes to develop fast and accurate photoresist models but also by helping process engineers more quickly identify problematic geometries that limit yield and develop new OPC recipes and geometries.

The reinforcement learning methods disclosed herein that are applied to the multi-domain problem of predicting photoresist contours (the problem being multi-domain in that multiple components (optical imaging models, analytical chemistry kernels, photoresist development model terms, analytical deformation kernels) are used to model the photolithography process) can be applied to other multi-domain calibration problems as well. For example, a compact, fast and accurate model may be desired to predict the efficiency of an engine, and the technologies described herein can develop a calibrated model by iteratively calibrating a set of candidate engine models based on a set of models that model various engine components or processes (a computational fluid dynamics model, friction models that model the friction between various engine parts, etc.), and using the disclosed reinforcement learning methods to iterative generate improved engine models until a final engine model having sufficient predictive accuracy is developed.

The reinforcement learning technologies described herein can be used to develop predictive models for generic multi-domain problems. For example, a calibrated model may be desired to predict an outcome of any system or process for which a set of parameterized candidate models, model terms, or kernels have been developed to model the behavior of constituent components or stages of the system or process. An initial set of candidate models is selected for an initial iteration of a reinforcement method, with individual of the candidate models comprising one or more models, model terms, or kernels for the constituent components or stages of the system or process. A set of calibration parameters for the individual candidate models are selected as well. For each candidate model, the artificial intelligence approaches described herein determine calibrated values for the selected calibration parameters and select the models, model terms, or kernels for each constituent component or stage that are the most determinant in accurately predicting the system or process outcome. The most useful models, model terms, or kernels are retained in the individual candidate model and the remaining models, model terms, or kernels are left out of the individual candidate model. The candidate models for the initial iteration that most accurately predict the system or process outcome are identified and used as parent models by a genetic algorithm to generate child models that are used as candidate models for the next iteration of the reinforcement learning method. Iterations are repeated until the reinforcement learning method converges. The resulting candidate model is identified as a final model for predicting the selected outcome of the process or system.

The technologies, techniques and embodiments described herein can be performed by any of a variety of computing devices, including mobile devices (e.g., smartphones, handheld computers, tablet computers, laptop computers, media players, portable gaming consoles, cameras and video recorders), non-mobile devices (e.g., desktop computers, servers, stationary gaming consoles, set-top boxes, smart televisions) and embedded devices (e.g., devices incorporated into a vehicle, home or place of business). As used herein, the term “computing devices” includes computing systems and includes devices comprising multiple discrete physical components.

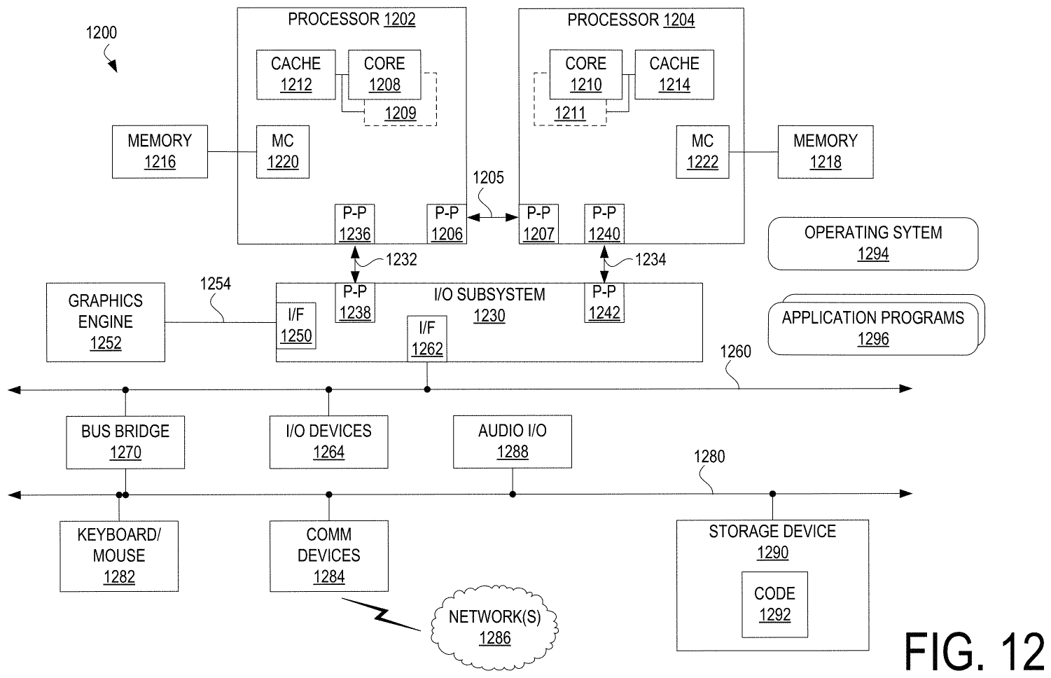

FIG. 12 is a block diagram of a second exemplary computing device 1200 in which technologies described herein may be implemented. Generally, components shown in FIG. 12 can communicate with other shown components, although not all connections are shown, for ease of illustration. The device 1200 is a multiprocessor system comprising a first processor 1202 and a second processor 1204 and is illustrated as comprising point-to-point (P-P) interconnects. For example, a point-to-point (P-P) interface 1206 of the processor 1202 is coupled to a point-to-point interface 1207 of the processor 1204 via a point-to-point interconnection 1205. It is to be understood that any or all of the point-to-point interconnects illustrated in FIG. 12 can be alternatively implemented as a multi-drop bus, and that any or all buses illustrated in FIG. 12 could be replaced by point-to-point interconnects.

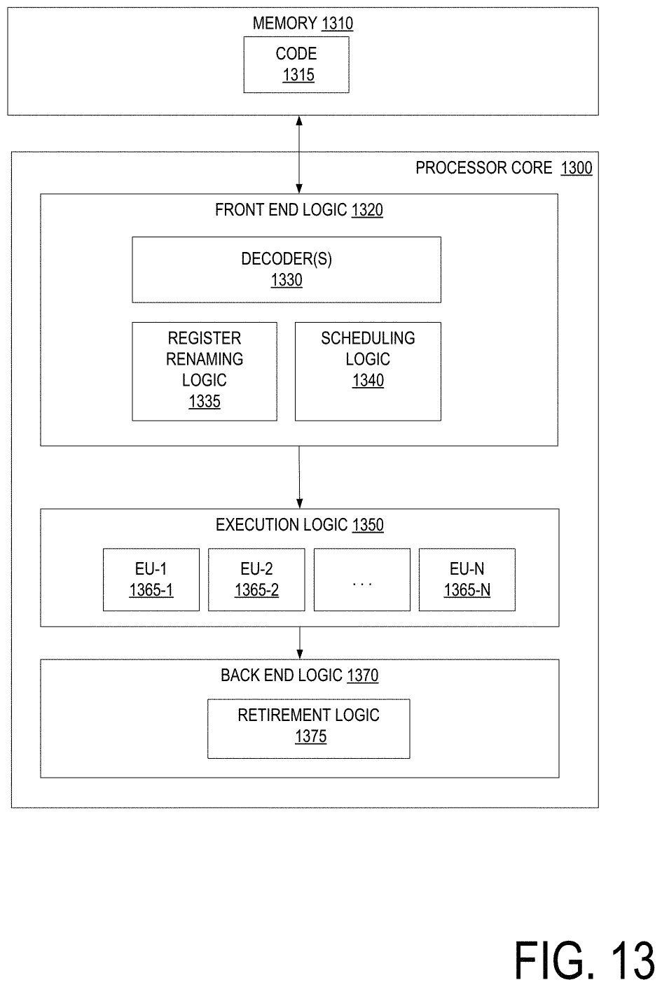

As shown in FIG. 12, the processors 1202 and 1204 are multicore processors. Processor 1202 comprises processor cores 1208 and 1209, and processor 1204 comprises processor cores 1210 and 1211. Processor cores 1208-1211 can execute computer-executable instructions in a manner similar to that discussed below in connection with FIG. 13, or in other manners.

Processors 1202 and 1204 further comprise at least one shared cache memory 1212 and 1214, respectively. The shared caches 1212 and 1214 can store data (e.g., instructions) utilized by one or more components of the processor, such as the processor cores 1208-1209 and 1210-1211. The shared caches 1212 and 1214 can be part of a memory hierarchy for the device 1200. For example, the shared cache 1212 can locally store data that is also stored in a memory 1216 to allow for faster access to the data by components of the processor 1202. In some embodiments, the shared caches 1212 and 1214 can comprise multiple cache layers, such as level 1 (L1), level 2 (L2), level 3 (L3), level 4 (L4), and/or other caches or cache layers, such as a last level cache (LLC).

Although the device 1200 is shown with two processors, the device 1200 can comprise any number of processors. Further, a processor can comprise any number of processor cores. A processor can take various forms such as a central processing unit, a controller, a graphics processor, an accelerator (such as a graphics accelerator or digital signal processor (DSP)) or a field programmable gate array (FPGA). A processor in a device can be the same as or different from other processors in the device. In some embodiments, the device 1200 can comprise one or more processors that are heterogeneous or asymmetric to a first processor, accelerator, FPGA, or any other processor. There can be a variety of differences between the processing elements in a system in terms of a spectrum of metrics of merit including architectural, microarchitectural, thermal, power consumption characteristics and the like. These differences can effectively manifest themselves as asymmetry and heterogeneity amongst the processors in a system. In some embodiments, the processors 1202 and 1204 reside in the same die package.

Processors 1202 and 1204 further comprise memory controller logic (MC) 1220 and 1222. As shown in FIG. 12, MCs 1220 and 1222 control memories 1216 and 1218 coupled to the processors 1202 and 1204, respectively. The memories 1216 and 1218 can comprise various types of memories, such as volatile memory (e.g., dynamic random-access memories (DRAM), static random-access memory (SRAM)) or non-volatile memory (e.g., flash memory). While MCs 1220 and 1222 are illustrated as being integrated into the processors 1202 and 1204, in alternative embodiments, the MCs can be logic external to a processor and can comprise one or more layers of a memory hierarchy.

Processors 1202 and 1204 are coupled to an Input/Output (I/O) subsystem 1230 via P-P interconnections 1232 and 1234. The point-to-point interconnection 1232 connects a point-to-point interface 1236 of the processor 1202 with a point-to-point interface 1238 of the I/O subsystem 1230, and the point-to-point interconnection 1234 connects a point-to-point interface 1240 of the processor 1204 with a point-to-point interface 1242 of the I/O subsystem 1230. Input/Output subsystem 1230 further includes an interface 1250 to couple I/O subsystem 1230 to a graphics engine 1252, which can be a high-performance graphics engine. The I/O subsystem 1230 and the graphics engine 1252 are coupled via a bus 1254. Alternately, the bus 1254 could be a point-to-point interconnection.

Input/Output subsystem 1230 is further coupled to a first bus 1260 via an interface 1262. The first bus 1260 can be a Peripheral Component Interconnect (PCI) bus, a PCI Express bus, another third-generation I/O interconnection bus or any other type of bus.

Various I/O devices 1264 can be coupled to the first bus 1260. A bus bridge 1270 can couple the first bus 1260 to a second bus 1280. In some embodiments, the second bus 1280 can be a low pin count (LPC) bus. Various devices can be coupled to the second bus 1280 including, for example, a keyboard/mouse 1282, audio I/O devices 1288 and a storage device 1290, such as a hard disk drive, solid-state drive or other storage devices for storing computer-executable instructions (code) 1292. The code 1292 can comprise computer-executable instructions for performing technologies described herein. Additional components that can be coupled to the second bus 1280 include communication device(s) 1284, which can provide for communication between the device 1200 and one or more wired or wireless networks 1286 (e.g. Wi-Fi, cellular or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

The device 1200 can comprise removable memory such as flash memory cards (e.g., SD (Secure Digital) cards), memory sticks, Subscriber Identity Module (SIM) cards). The memory in device 1200 (including caches 1212 and 1214, memories 1216 and 1218 and storage device 1290) can store data and/or computer-executable instructions for executing an operating system 1294 and application programs 1296. Example data includes web pages, text messages, images, sound files, video data, biometric thresholds for particular users or other data sets to be sent to and/or received from one or more network servers or other devices by the device 1200 via one or more wired or wireless networks, or for use by the device 1200. The device 1200 can also have access to external memory (not shown) such as external hard drives or cloud-based storage.

The operating system 1294 can control the allocation and usage of the components illustrated in FIG. 12 and support one or more application programs 1296. The application programs 1296 can include common mobile computing device applications (e.g., email applications, calendars, contact managers, web browsers, messaging applications) as well as other computing applications.

The device 1200 can support various input devices, such as a touch screen, microphone, camera, physical keyboard, proximity sensor and trackball, and one or more output devices, such as a speaker and a display. Other possible input and output devices include piezoelectric and other haptic I/O devices. Any of the input or output devices can be internal to, external to or removably attachable with the device 1200. External input and output devices can communicate with the device 1200 via wired or wireless connections.

In addition, the computing device 1200 can provide one or more natural user interfaces (NUIs). For example, the operating system 1294 or applications 1296 can comprise speech recognition logic as part of a voice user interface that allows a user to operate the device 1200 via voice commands. Further, the device 1200 can comprise input devices and logic that allows a user to interact with the device 1200 via a body, hand or face gestures. For example, a user's hand gestures can be detected and interpreted to provide input to a gaming application.

The device 1200 can further comprise one or more communication components 1284. The components 1284 can comprise wireless communication components coupled to one or more antennas to support communication between the system 1200 and external devices. The wireless communication components can support various wireless communication protocols and technologies such as Near Field Communication (NFC), Wi-Fi, Bluetooth, 4G Long Term Evolution (LTE), Code Division Multiplexing Access (CDMA), Universal Mobile Telecommunication System (UMTS) and Global System for Mobile Telecommunication (GSM). In addition, the wireless modems can support communication with one or more cellular networks for data and voice communications within a single cellular network, between cellular networks, or between the mobile computing device and a public switched telephone network (PSTN).

The device 1200 can further include at least one input/output port (which can be, for example, a USB, IEEE 1394 (FireWire), Ethernet and/or RS-232 port) comprising physical connectors; a power supply; a satellite navigation system receiver, such as a GPS receiver; a gyroscope; an accelerometer; a proximity sensor; and a compass. A GPS receiver can be coupled to a GPS antenna. The device 1200 can further include one or more additional antennas coupled to one or more additional receivers, transmitters and/or transceivers to enable additional functions.

It is to be understood that FIG. 12 illustrates only one exemplary computing device architecture. Computing devices based on alternative architectures can be used to implement technologies described herein. For example, instead of the processors 1202 and 1204, and the graphics engine 1252 being located on discrete integrated circuits, a computing device can comprise an SoC (system-on-a-chip) integrated circuit incorporating multiple processors, a graphics engine and additional components. Further, a computing device can connect elements via bus or point-to-point configurations different from that shown in FIG. 12. Moreover, the illustrated components in FIG. 12 are not required or all-inclusive, as shown components can be removed and other components added in alternative embodiments.

FIG. 13 is a block diagram of an exemplary processor core 1300 to execute computer-executable instructions as part of implementing technologies described herein. The processor core 1300 can be a core for any type of processor, such as a microprocessor, an embedded processor, a digital signal processor (DSP) or a network processor. The processor core 1300 can be a single-threaded core or a multithreaded core in that it may include more than one hardware thread context (or “logical processor”) per core.

FIG. 13 also illustrates a memory 1310 coupled to the processor 1300. The memory 1310 can be any memory described herein or any other memory known to those of skill in the art. The memory 1310 can store computer-executable instruction 1315 (code) executable by the processor core 1300.

The processor core comprises front-end logic 1320 that receives instructions from the memory 1310. An instruction can be processed by one or more decoders 1330. The decoder 1330 can generate as its output a micro-operation such as a fixed width micro operation in a predefined format, or generate other instructions, microinstructions, or control signals, which reflect the original code instruction. The front-end logic 1320 further comprises register renaming logic 1335 and scheduling logic 1340, which generally allocate resources and queues operations corresponding to converting an instruction for execution.

The processor core 1300 further comprises execution logic 1350, which comprises one or more execution units (EUs) 1365-1 through 1365-N. Some processor core embodiments can include a number of execution units dedicated to specific functions or sets of functions. Other embodiments can include only one execution unit or one execution unit that can perform a function. The execution logic 1350 performs the operations specified by code instructions. After completion of execution of the operations specified by the code instructions, back-end logic 1370 retires instructions using retirement logic 1375. In some embodiments, the processor core 1300 allows out of order execution but requires in-order retirement of instructions. Retirement logic 1370 can take a variety of forms as known to those of skill in the art (e.g., re-order buffers or the like).

The processor core 1300 is transformed during execution of instructions, at least in terms of the output generated by the decoder 1330, hardware registers and tables utilized by the register renaming logic 1335, and any registers (not shown) modified by the execution logic 1350. Although not illustrated in FIG. 13, a processor can include other elements on an integrated chip with the processor core 1300. For example, a processor may include additional elements such as memory control logic, one or more graphics engines, I/O control logic and/or one or more caches.

As used in any embodiment herein, the term “module” refers to logic that may be implemented in a hardware component or device, software or firmware running on a processor, or a combination thereof, to perform one or more operations consistent with the present disclosure. Software may be embodied as a software package, code, instructions, instruction sets, and/or data recorded on non-transitory computer readable storage mediums. Firmware may be embodied as code, instructions or instruction sets and/or data that are hard-coded (e.g., nonvolatile) in memory devices. As used in any embodiment herein, the term “circuitry” can comprise, for example, singly or in any combination, hardwired circuitry, programmable circuitry such as computer processors comprising one or more individual instruction processing cores, state machine circuitry, and/or firmware that stores instructions executed by programmable circuitry. Modules described herein may, collectively or individually, be embodied as circuitry that forms a part of one or more devices. Thus, any of the modules can be implemented as circuitry, such as continuous itemset generation circuitry, entropy-based discretization circuitry, etc. A computer device referred to as being programmed to perform a method can be programmed to perform the method via software, hardware, firmware or combinations thereof.

Any of the disclosed methods can be implemented as computer-executable instructions or a computer program product. Such instructions can cause a computer or one or more processors capable of executing computer-executable instructions to perform any of the disclosed methods. Generally, as used herein, the term “computer” refers to any computing device or system described or mentioned herein, or any other computing device. Thus, the term “computer-executable instruction” refers to instructions that can be executed by any computing device described or mentioned herein, or any other computing device.

The computer-executable instructions or computer program products as well as any data created and used during implementation of the disclosed technologies can be stored on one or more tangible or non-transitory computer-readable storage media, such as optical media discs (e.g., DVDs, CDs), volatile memory components (e.g., DRAM, SRAM), or non-volatile memory components (e.g., flash memory, solid-state drives, chalcogenide-based phase-change non-volatile memories). Computer-readable storage media can be contained in computer-readable storage devices such as solid-state drives, USB flash drives, and memory modules. Alternatively, the computer-executable instructions may be performed by specific hardware components that contain hardwired logic for performing all or a portion of disclosed methods, or by any combination of computer-readable storage media and hardware components.

The computer-executable instructions can be part of, for example, a dedicated software application or a software application that is accessed via a web browser or other software application (such as a remote computing application). Such software can be read and executed by, for example, a single computing device or in a network environment using one or more networked computers. Further, it is to be understood that the disclosed technology is not limited to any specific computer language or program. For instance, the disclosed technologies can be implemented by software written in C++, Java, Perl, JavaScript, Adobe Flash, or any other suitable programming language. Likewise, the disclosed technologies are not limited to any particular computer or type of hardware.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrase “at least one of A, B or C” can mean A; B; C; A and B; A and C; B and C; or A, B, and C.

The disclosed methods, apparatuses and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 is a method comprising: (i) determining a plurality of candidate photoresist models, individual of the candidate photoresist models comprising one or more analytical kernels; (ii) for individual of the candidate photoresist models, developing a calibrated candidate photoresist model by fitting the individual candidate photoresist model to training photoresist contours extracted from scanning electron microscopy (SEM) image data; (iii) selecting the calibrated candidate photoresist model from among the calibrated candidate photoresist models that best predicts the training photoresist contours as a best calibrated candidate photoresist model; (iv) iteratively repeating (i) through (iii) until the predictive accuracy of the best calibrated candidate photoresist model of a current iteration of (i) through (iii) is no better than the predictive accuracy of the best calibrated candidate photoresist model of a prior iteration of (i) through (iii), the plurality of candidate photoresist models determined in a next iteration of (i) through (iii) being determined at least in part by a genetic algorithm operating on at least the best calibrated candidate photoresist model from the current iteration; (v) identifying the best calibrated candidate photoresist model from a last iteration of (i) through (iii) as a final photoresist model; and (vi) using the final photoresist model to predict device photoresist contours based at least in part on device photomask data.

Example 2 is the method of Example 1, wherein individual of the candidate photoresist models further comprises an optical imaging model and one or more photoresist development model terms.

Example 3 is the method of Example 2, wherein individual of the candidate photoresist models further comprises a plurality of model parameters associated with at least one of the optical imaging model, the analytical kernels, or the photoresist development models terms.

Example 4 is the method of Example 3, wherein the model parameters for the individual candidate photoresist models comprise one or more optical imaging parameters corresponding to the optical imaging model, one or more analytical kernel parameters corresponding to the analytical kernels, and one or more photoresist development model term parameters corresponding to the one or more photoresist development model terms.

Example 5 is the method of Example 3, wherein at least one of the model parameters for the individual candidate photoresist models is a non-linear model parameter.

Example 6 is the method of Example 3, wherein the developing a calibrated candidate photoresist model for individual of the candidate photoresist models by fitting the individual candidate photoresist model to the training photoresist contours comprises, for individual of the candidate photoresist models: selecting one or more calibration model parameters from the model parameters; and; using one or more supervised learning algorithms to determine calibrated values for the calibration model parameters and to determine one or more useful analytical kernels from the analytical kernels by fitting the individual candidate photoresist model to the training photoresist contours to develop the calibrated version of the individual candidate photoresist model, wherein the calibrated candidate photoresist model includes the useful analytical kernels and does not include analytical kernels not identified as useful.

Example 7 is the method of Example 6, wherein the one or more supervised learning algorithms comprises the training of an artificial neural network.

Example 8 is the method of Example 6, the method further comprising training a residual minimization model to correct residual errors in the final photoresist model.

Example 9 is the method of Example 8, the using the final photoresist model to predict device photoresist contours comprising using the residual minimization model.

Example 10 is the method of Example 6, wherein the analytical kernels of the final photoresist model comprise one or more analytical chemistry kernels and one or more analytical deformation kernels, the using the final photoresist model to predict device photoresist contours comprising: applying the optical imaging model of the final photoresist model to the device photomask data to generate a light intensity image; applying the one or more analytical chemistry kernels of the final photoresist model to the light intensity image to generate a photoresist exposure image; applying the one or more photoresist development model terms to the photoresist exposure image to generate initial photoresist contours; and applying the one or more analytical deformation kernels of the final photoresist model to the initial photoresist contours and the photoresist exposure image to predict the device photoresist contours.

Example 11 is the method of Example 10, further comprising using a residual minimization model to correct residual errors in the predicted device photoresist contours.

Example 12 is the method of Example 10, wherein the applying the one or more analytical deformation kernels of the final photoresist model to the initial photoresist contours and the photoresist exposure image to predict device photoresist contours further comprises: breaking the initial photoresist contours into smaller chunks for which the analytical deformation kernels provide a known solution; predicting device photoresist contours for the smaller chunks; and stitching together the predicted device photoresist contours for the smaller chunks to predict the device photoresist contours.

Example 13 is the method of Example 1, wherein the analytical kernels in individual photoresist models comprise at least one analytical chemistry kernel and at least one analytical deformation kernel.

Example 14 is the method of Example 13, wherein the at least one analytical chemistry kernels are from a plurality of candidate analytical chemistry kernels, and the at least one analytical deformation kernels are from a plurality of candidate analytical deformation kernels.

Example 15 is the method of Example 1, wherein the final photoresist model is a multi-stage model.

Example 16 is the method of Example 1, wherein the candidate photoresist models determined for the next iteration of (i) through (iii) comprise the best candidate photoresist model for the current iteration of (i) through (iii).

Example 17 is the method of Example 1, wherein individual of at least some of the candidate photoresist models determined for the next iteration of (i) through (iii) is generated by the genetic algorithm operating on different pairs of candidate photoresist models from the current iteration of (i) through (iii).

Example 18 is the method of Example 1, wherein the best calibrated candidate photoresist model selected in (iii) most accurately predicts validation photoresist contours extracted from SEM image data as well most accurately predicts the training photoresist contours.

Example 19 is a photoresist modeling system comprising one or more processors and one or more computer-readable storage media storing instructions thereon for causing the one or more processors to perform any of the methods of Examples 1 through 18.

Example 20 is one or more computer-readable storage media storing instructions thereon for causing a computing device to perform any of the methods of Examples 1 through 18.

Example 21 is a method comprising: applying an optical imaging model to photomask data to generate a light intensity image; applying one or more analytical chemistry kernels to the light intensity image to generate a photoresist exposure image; applying one or more photoresist development model terms to the photoresist exposure image to generate initial photoresist contours; and applying one or more analytical deformation kernels of the final photoresist model to the initial photoresist contours and the photoresist exposure image to generate predicted device photoresist contours for a region of photoresist corresponding to the photomask data.

Example 22 is the method of Example 21, the optical imaging model comprising one or more optical imaging model parameters, a value for at least one of the optical imaging model parameters taken from optics data.

Example 23 is the method of Example 21, the one or more analytical deformation kernels comprising one or more analytical deformation kernel parameters, the one or more analytical deformation kernel parameters comprising at least one of nominal photoresist shrinkage amount, photoresist elasticity, distance scaling for photoresist shrinkage effects, coefficients for local boundary shape attributes, and coefficients for geometric measures of neighboring contours.

Example 24 is the method of Example 21, the one or more analytical chemistry kernels comprising one or more analytical chemistry kernel parameters, the one or more analytical chemistry kernel parameters comprising at least one reaction and diffusion model parameters for chemically amplified resists such as acid production rate as a function of the local intensity, acid diffusion length as a function of intensity, acid loss rates, and photoresist polymer de-protection rate as a function of the local acid concentration after acid loss and diffusion.

Example 25 is a system comprising: one or more processors; one or more computer-readable storage media storing instructions thereon for causing the one or more processors to perform any of the methods of Example 21 through 24.

Example 26 is one or more computer-readable storage media storing instructions thereon for causing a computing device to perform any of the methods of Example 21 through 24.

We claim:

1. A method comprising:
(i) determining a plurality of candidate photoresist models, individual of the candidate photoresist models comprising one or more analytical kernels;
(ii) for individual of the candidate photoresist models, developing a calibrated candidate photoresist model by fitting the individual candidate photoresist model to training photoresist contours extracted from scanning electron microscopy (SEM) image data;
(iii) selecting the calibrated candidate photoresist model from among the calibrated candidate photoresist models that best predicts the training photoresist contours as a best calibrated candidate photoresist model;
(iv) iteratively repeating (i) through (iii) until the predictive accuracy of the best calibrated candidate photoresist model of a current iteration of (i) through (iii) is no better than the predictive accuracy of the best calibrated candidate photoresist model of a prior iteration of (i) through (iii), the plurality of candidate photoresist models determined in a next iteration of (i) through (iii) being determined at least in part by a genetic algorithm operating on at least the best calibrated candidate photoresist model from the current iteration;
(v) identifying the best calibrated candidate photoresist model from a last iteration of (i) through (iii) as a final photoresist model; and
(vi) using the final photoresist model to predict device photoresist contours based at least in part on device photomask data.

2. The method of claim 1, wherein individual of the candidate photoresist models further comprises an optical imaging model and one or more photoresist development model terms.

3. The method of claim 2, wherein individual of the candidate photoresist models further comprises a plurality of model parameters associated with at least one of the optical imaging model, the analytical kernels, or the photoresist development models terms.

4. The method of claim 3, wherein the model parameters for the individual candidate photoresist models comprise one or more optical imaging parameters corresponding to the optical imaging model, one or more analytical kernel parameters corresponding to the analytical kernels, and one or more photoresist development model term parameters corresponding to the one or more photoresist development model terms.

5. The method of claim 3, wherein the developing a calibrated candidate photoresist model for individual of the candidate photoresist models by fitting the individual candidate photoresist model to the training photoresist contours comprises, for individual of the candidate photoresist models:
selecting one or more calibration model parameters from the model parameters; and;
using one or more supervised learning algorithms to determine calibrated values for the calibration model parameters and to determine one or more useful analytical kernels from the analytical kernels by fitting the individual candidate photoresist model to the training photoresist contours to develop the calibrated version of the individual candidate photoresist model, wherein the calibrated candidate photoresist model includes the useful analytical kernels and does not include analytical kernels not identified as useful.

6. The method of claim 1, wherein the analytical kernels in individual photoresist models comprise at least one analytical chemistry kernel and at least one analytical deformation kernel.

7. A system comprising:
one or more processors; and
one or more computer-readable storage media storing instructions thereon for causing the one or more processors to perform a method comprising:
(i) determining a plurality of candidate photoresist models, individual of the candidate photoresist models comprising one or more analytical kernels;
(ii) for individual of the candidate photoresist models, developing a calibrated candidate photoresist model by fitting the individual candidate photoresist model to training photoresist contours extracted from scanning electron microscopy (SEM) image data;
(iii) selecting the calibrated candidate photoresist model from among the calibrated candidate photoresist models that best predicts the training photoresist contours as a best calibrated candidate photoresist model;
(iv) iteratively repeating (i) through (iii) until the predictive accuracy of the best calibrated candidate photoresist model of a current iteration of (i) through (iii) is no better than the predictive accuracy of the best calibrated candidate photoresist model of a prior iteration of (i) through (iii), the plurality of candidate photoresist models determined in a next iteration of (i) through (iii) being determined at least in part by a genetic algorithm operating on at least the best calibrated candidate photoresist model from the current iteration;
(v) identifying the best calibrated candidate photoresist model from a last iteration of (i) through (iii) as a final photoresist model; and
(vi) using the final photoresist model to predict device photoresist contours based at least in part on device photomask data.

8. The system of claim 7, wherein individual of the candidate photoresist models further comprises an optical imaging model and one or more photoresist development model terms.

9. The system of claim 8, wherein individual of the candidate photoresist models further comprises a plurality of model parameters associated with at least one of the optical imaging model, the analytical kernels, or the photoresist development models terms.

10. The system of claim 9, wherein the model parameters for the individual candidate photoresist models comprise one or more optical imaging parameters corresponding to the optical imaging model, one or more analytical kernel parameters corresponding to the analytical kernels, and one or more photoresist development model term parameters corresponding to the one or more photoresist development model terms.

11. The system of claim 10, wherein at least one of the model parameters for the individual candidate photoresist models is a non-linear model parameter.

12. The system of claim 10, wherein the developing a calibrated candidate photoresist model for individual of the candidate photoresist models by fitting the individual candidate photoresist model to the training photoresist contours comprises, for individual of the candidate photoresist models:
selecting one or more calibration model parameters from the model parameters; and;
using one or more supervised learning algorithms to determine calibrated values for the calibration model parameters and to determine one or more useful analytical kernels from the analytical kernels by fitting the individual candidate photoresist model to the training photoresist contours to develop the calibrated version of the individual candidate photoresist model, wherein the calibrated candidate photoresist model includes the useful analytical kernels and does not include analytical kernels not identified as useful.

13. The system of claim 12, wherein the one or more supervised learning algorithms comprises the training of an artificial neural network.

14. The system of claim 12, the method further comprising training a residual minimization model to correct residual errors in the final photoresist model, wherein the using the final photoresist model to predict device photoresist contours comprising using the residual minimization model.

15. The system of claim 12, wherein the analytical kernels of the final photoresist model comprise one or more analytical chemistry kernels and one or more analytical deformation kernels, the using the final photoresist model to predict device photoresist contours comprising:
applying the optical imaging model of the final photoresist model to the device photomask data to generate a light intensity image;
applying the one or more analytical chemistry kernels of the final photoresist model to the light intensity image to generate a photoresist exposure image;
applying the one or more photoresist development model terms to the photoresist exposure image to generate initial photoresist contours; and
applying the one or more analytical deformation kernels of the final photoresist model to the initial photoresist contours and the photoresist exposure image to predict the device photoresist contours.

16. The system of claim 15, wherein the applying the one or more analytical deformation kernels of the final photoresist model to the initial photoresist contours and the photoresist exposure image to predict device photoresist contours further comprises:
breaking the initial photoresist contours into smaller chunks for which the analytical deformation kernels provide a known solution;
predicting device photoresist contours for the smaller chunks; and
stitching together the predicted device photoresist contours for the smaller chunks to predict the device photoresist contours.

17. The system of claim 7, wherein the analytical kernels in individual photoresist models comprise at least one analytical chemistry kernel and at least one analytical deformation kernel.

18. The system of claim 7, wherein the candidate photoresist models determined for the next iteration of (i) through (iii) comprise the best candidate photoresist model for the current iteration of (i) through (iii).

19. The system of claim 7, wherein individual of at least some of the candidate photoresist models determined for the next iteration of (i) through (iii) is generated by the genetic algorithm operating on different pairs of candidate photoresist models from the current iteration of (i) through (iii).

20. The system of claim 7, wherein the best calibrated candidate photoresist model selected in (iii) most accurately predicts validation photoresist contours extracted from SEM image data as well most accurately predicts the training photoresist contours.

21. One or more computer-readable storage media storing instructions thereon for causing a computing device to perform a method comprising:
(i) determining a plurality of candidate photoresist models, individual of the candidate photoresist models comprising one or more analytical kernels;
(ii) for individual of the candidate photoresist models, developing a calibrated candidate photoresist model by fitting the individual candidate photoresist model to training photoresist contours extracted from scanning electron microscopy (SEM) image data;
(iii) selecting the calibrated candidate photoresist model from among the calibrated candidate photoresist models that best predicts the training photoresist contours as a best calibrated candidate photoresist model;
(iv) iteratively repeating (i) through (iii) until the predictive accuracy of the best calibrated candidate photoresist model of a current iteration of (i) through (iii) is no better than the predictive accuracy of the best calibrated candidate photoresist model of a prior iteration of (i) through (iii), the plurality of candidate photoresist models determined in a next iteration of (i) through (iii) being determined at least in part by a genetic algorithm operating on at least the best calibrated candidate photoresist model from the current iteration;
(v) identifying the best calibrated candidate photoresist model from a last iteration of (i) through (iii) as a final photoresist model; and
(vi) using the final photoresist model to predict device photoresist contours based at least in part on device photomask data.

22. The one or more computer-readable storage media of claim 21, wherein individual of the candidate photoresist models further comprises an optical imaging model and one or more photoresist development model terms, and wherein individual of the candidate photoresist models further comprises a plurality of model parameters associated with at least one of the optical imaging model, the analytical kernels, or the photoresist development models terms.

23. The one or more computer-readable storage media of claim 22, wherein the model parameters for the individual candidate photoresist models comprise one or more optical imaging parameters corresponding to the optical imaging model, one or more analytical kernel parameters corresponding to the analytical kernels, and one or more photoresist development model term parameters corresponding to the one or more photoresist development model terms.

24. The one or more computer-readable storage media of claim 23, wherein the developing a calibrated candidate photoresist model for individual of the candidate photoresist models by fitting the individual candidate photoresist model to the training photoresist contours comprises, for individual of the candidate photoresist models:
selecting one or more calibration model parameters from the model parameters; and;
using one or more supervised learning algorithms to determine calibrated values for the calibration model parameters and to determine one or more useful analytical kernels from the analytical kernels by fitting the individual candidate photoresist model to the training photoresist contours to develop the calibrated version of the individual candidate photoresist model, wherein the calibrated candidate photoresist model includes the useful analytical kernels and does not include analytical kernels not identified as useful.

25. The one or more computer-readable storage media of claim 21, wherein the analytical kernels in individual photoresist models comprise at least one analytical chemistry kernel and at least one analytical deformation kernel.
